(19) United States
(12) Patent Application Publication
(10) Pub. No.: US 2003/0236977 A1
(43) Pub. Date: Dec. 25, 2003

(54) Method and system for providing secure access to applications

(76) Inventors: Robert George Levas, Mt. Laurel, NJ (US); Carl Allen Gunter, Philadelphia, PA (US); Michael Goldstein, Princeton, NJ (US); Hong Xiang Gao, Downingtown, PA (US); Benjamin Paul Hollin, Havertown, PA (US); Ron Reuven Lin, Philadelphia, PA (US); Michael Francis McDougall, Philadelphia, PA (US); David J. Ruggieri, Flourtown, PA (US); Vincent Louis, Unionville, PA (US); Michael C. Berry, Philadelphia, PA (US)

Correspondence Address: Daniel H. Golub, 1701 Market Street, Philadelphia, PA, 19103, US

(21) Appl. No.: 10/339,792

(22) Filed: Jan. 9, 2003

Related U.S. Application Data
(63) Continuation-in-part of application No. 09/842,266, filed on Apr. 25, 2001.
(63) Continuation-in-part of application No. 09/841,732, filed on Apr. 25, 2001.
(63) Continuation-in-part of application No. 09/842,268, filed on Apr. 25, 2001.
(63) Continuation-in-part of application No. 09/841,733, filed on Apr. 25, 2001.
(63) Continuation-in-part of application No. 09/842,267, filed on Apr. 25, 2001.
(63) Continuation-in-part of application No. 09/841,731, filed on Apr. 25, 2001.
(63) Continuation-in-part of application No. 09/842,269, filed on Apr. 25, 2001.
(63) Continuation-in-part of application No. 10/090,689, filed on Mar. 5, 2002.
(63) Continuation-in-part of application No. 10/090,680, filed on Mar. 5, 2002.
(63) Continuation-in-part of application No. 10/090,681, filed on Mar. 5, 2002.
(63) Continuation-in-part of application No. 10/090,679, filed on Mar. 5, 2002.
(60) Provisional application No. 60/347,392, filed on Jan. 9, 2002.
(60) Provisional application No. 60/378,305, filed on May 7, 2002.

(51) Int. Cl. H04L 9/00

(52) U.S. Cl. 713/158

(57) ABSTRACT

An administrative user is authenticated to a server and authorized to delegate permission to a user to access an application. A request from the administrative user to delegate permission to the user is received at the server. A request from the user to register with the server is received at the server. The user is provided access to the application. The administrative user authenticates the user with non-secret information. The communications take place over a computer network.

### CROSS REFERENCE TO RELATED APPLICATIONS

This application claims priority to U.S. Provisional Patent Application Nos. 60/347,392 filed Jan. 9, 2002, and 60/378,305 filed May 7, 2002 and is a continuation-in-part of U.S. patent application Ser. Nos. 09/842,266; 09/841,732; 09/842,268; 09/841,733; 09/842,267; 09/841,731; and 09/842,269; each filed Apr. 25, 2001; and Nos. 10/090,689; 10/090,680; 10/090,681; and 10/090,679; each filed Mar. 5, 2002.

### STATEMENT REGARDING FEDERALLY SPONSORED RESEARCH

Not applicable.

### BACKGROUND OF THE INVENTION

1. Field of the Invention

The present invention is directed generally to methods and systems for providing secure access to applications over computer networks.

2. Description of the Background

Maintaining security and privacy with respect to certain information is of great importance to many industries, such as the healthcare industry, as well as to the government. While various systems exist for providing individuals access to information in a secure fashion, such systems are less than ideal. For example, existing systems require IT administrators to build lists of authorized individuals, thereby requiring involvement of IT administrators every time a new individual is to be provided with secure access to information.

Further, some existing systems are tied to organizational models of roles. In particular, individuals on a particular access list are assigned to roles by virtue of their job function or departmental affiliation and are thereby granted access to confidential information generally deemed appropriate for their role. Such systems are not useful in situations in which different organizations cooperate on a project or otherwise have a need to share data. Also, in the cooperative organization situation, each of the users requiring access to an application may employ a different authentication modality and, thus, there is a need to accommodate a diverse group of users within a single system. Moreover, because such systems are role-based and not individualized, delegating access to applications on a need-to-know basis becomes cumbersome. Other security models are rules-based (e.g., customers who register and provide a valid credit card may open an account and view certain information). Such rules-based systems make auditing access to information difficult and implementation on a large scale expensive.

While existing systems allow organizations to control access to information at a high level (i.e., a user may gain access to an application and delegate such access to others or not), in certain circumstances, it may be advantageous to maintain more fine-grained control over such access. In addition, while certain existing security solutions allow reasonable protection in connection with providing access to permanent employees, such solutions are not acceptable for situations in which an individual is to be provided access to applications for a limited period of time (for example, a temporary employee, consultant, customer, supplier, or collaborator) or in which it may become necessary to revoke access rights quickly.

### BRIEF SUMMARY OF THE INVENTION

The present invention is directed to methods and systems for providing secure access to applications over a computer network. An administrative user who is authorized to delegate to a first user a permission to access an application authenticates to a server. A request is received at the server from the administrative user to delegate a first permission to access at least a portion of the application to the first user. The server receives a request from the first user to register with the server. The administrative user authenticates the first user with authentication information, which includes non-secret information. The first user is provided access to the application.

The present invention is also directed to methods and systems for delegation of permits with specialized limitations. A first user delegates to a second user permission to access an application. In connection with the delegation, an access control list is appended with the identity of the first user (the issuer); the identity of the second user (the subject); the identity of the application to which access is delegated; and a limitation on the number of further delegations the second user can make and, in some cases, a limitation on the length of the delegation chain. Upon authenticating the second user, the second user is provided with access to the application.

### BRIEF DESCRIPTION OF THE DRAWINGS

The accompanying drawings, wherein like referenced numerals are employed to designate like parts or steps, are included to provide a further understanding of the invention, are incorporated and constitute a part of this specification, and illustrate embodiments of the invention that together with the description serve to explain the principles of the invention.

In the drawings:

FIG. 1 illustrates a preferred embodiment of a system used in connection with the present invention.

FIG. 2 illustrates an exemplary database schema for storing data generated in connection with a preferred embodiment of the present invention.

FIGS. 3A-3D illustrate process flow diagrams illustrating one embodiment of the authorization, delegation, registration, and the authentication process flows, respectively, of the present invention.

FIGS. 3E-3G illustrate process flow diagrams illustrating an alternate embodiment of the access control, delegation, and retrieve delegation process flows, respectively, of the present invention.

FIGS. 4A-4Y illustrate exemplary user interfaces that may be used to access various aspects of the system, in accordance with a preferred embodiment of the present invention.

FIG. 5A is a flow chart illustrating a preferred embodiment of a method of the present invention.

FIGS. 5B-5E illustrate exemplary user interfaces that may be employed in connection with the present invention.

FIG. 6 is a flow chart illustrating a preferred embodiment of a method of the present invention.

### DETAILED DESCRIPTION

Among many other benefits, the present invention allows trusted users to delegate secure access to others, eliminating the need for an IT administrator continually to create and manage lists of users. Allowing for chained delegations (i.e., delegating the power to delegate) enables decision making as close as necessary to the front lines. In particular, decisions can be made by the people directly involved, who know the people to whom they are providing access and who are in the best position to administer secure authentication protocols. Moreover, the invention supports authentication and authorization in real-world, mixed environments where users employ different means for authentication. These and other advantages and benefits of the present invention will become apparent from the detailed description of the invention herein below.

Reference will now be made in detail to the preferred embodiments of the present invention, examples of which are illustrated in the accompanying drawings. It is to be understood that the figures and descriptions of the present invention included herein illustrate and describe elements that are of particular relevance to the present invention, while eliminating, for purposes of clarity, other elements. Those of ordinary skill in the art will recognize that other elements are desirable and/or required in order to implement the present invention. However, because such elements are well known in the art, and because they do not facilitate a better understanding of the present invention, a discussion of such elements is not provided herein.

The systems and methods disclosed herein relate to providing secure access to applications. An application may include any object, data, document, file, directory, text, software, computer application or other information to which secure access is desired. Such secure access is provided by way of delegations (also referred to herein as permits), pursuant to which privileges for a resource (i.e., pointers to applications) are passed from user to user. Users may only delegate existing resources, either ones that were delegated to them or ones that they created. In order to re-delegate a resource (the same or less access) that was delegated to the user, the user must be authorized to do so. Each delegation includes, in the preferred embodiment, an issuer; a subject; the desired resource; one or more constraints (e.g., validity period, authority to re-delegate etc.); a validity state; and, optionally, one or more attached files and/or a secure message.

Resources are qualified pointers to applications, which are uniquely identified by a resource identifier (“RI”). While in some embodiments, the RI may be a Uniform Resource Identifier (“URI”) or a Uniform Resource Locator (“URL”), which identify an electronic resource that belongs to a specific machine or file name, in other embodiments, the RI may identify a resource that represents a physical object, such as a door. In a preferred embodiment, the RI includes a mechanism used to access the resource, the specific location of the resource (e.g., the computer that houses the resource), and the specific name of the resource at that location (e.g., on the computer). For example, in an embodiment in which the application resides on a web server, the resource is identified by a URL, such as http://www.some_domain.com/someApp?Id=1&View=All.

Resource groups are logical groupings of RIs that are used in the authorization process to determine if a user is authorized to gain access to a particular application. While a particular permit delegated to a user may point to a single RI, this particular RI may be associated with a group of related RIs (i.e., a resource group) such that access to one RI may imply access to a group of RIs.

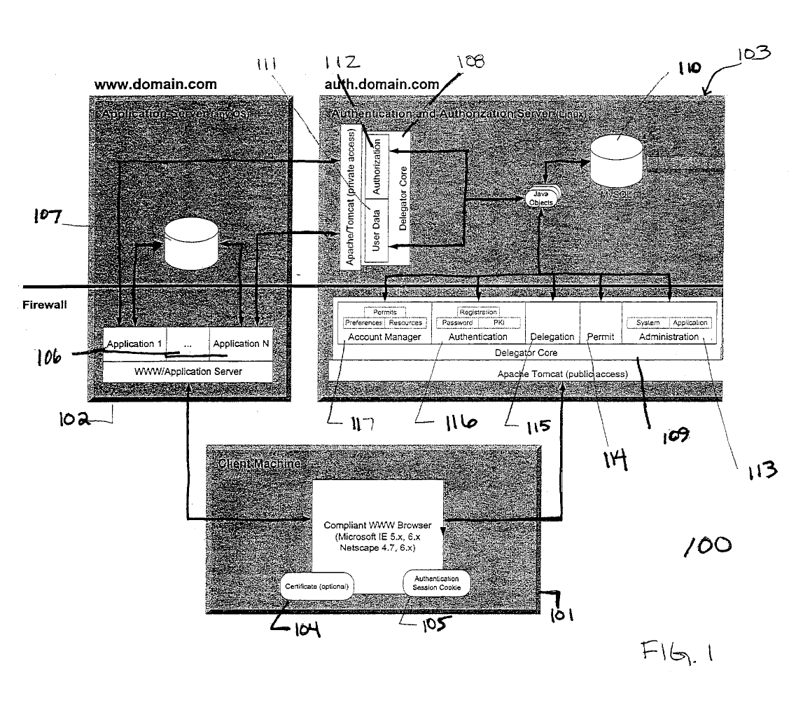

FIG. 1 depicts a preferred embodiment of a system 100, which may be used to support the present invention. The client/server configuration illustrated in FIG. 1 includes client 101, application server 102, and authentication/authorization server 103. While in the configuration of FIG. 1, application server 102 and authentication/authorization server 103 are shown as two separate servers, the components of and functionality performed by each server may be combined into a single server or may be spread out over multiple servers. Such alternate embodiments are within the scope of the present invention. Client 101, application server 102, and authentication/authorization server 103 are linked together to form a computer network, such as a local area network, a wide area network, or the Internet. Where the communications among client 101, application server 102, and authentication/authorization server 103 take place over the Internet, client 101 requires an SSL-enabled web browser.

Application server 102 maintains the applications 106 to which a user at client 101 seeks access. Database 107 stores information specific to the applications 106. Authentication/authorization server 103 includes the components that are used in connection with the authentication and authorization processes. In the preferred embodiment, application server 102 and authentication/authorization server 103 reside in same domain, given that the preferred embodiment of the invention is implemented using two cookies—a persistent cookie that contains user preference data, which is set on client 101 by authentication/authorization server 103, and a session cookie, which contains authentication information and is not stored to a disk. In other embodiments, however, the application server 102 and the authentication/authorization server 103 do not reside in the same domain. In these embodiments, authentication information (e.g., password, certificate etc.) is collected by the application server 102 and sent to the authentication/authorization server 103 for verification. The authentication/authorization server 103 then sends the data to be maintained in the cookie to the application server 102. The application server 102 then sets the cookie on the client 101, thereby eliminating the need for both the application server 102 and the authentication/authorization server 103 to reside in the same domain.

Component 108 of authentication/authorization server 103 encapsulates services available to applications 106 on application server 102. In the preferred embodiment, two types of services are available: authorization service 112 and user data service 111. Authorization service 112 may be used by an application 106 to query for authorization rights for a specific user regarding a specific resource. User data service 111 may be used by an application 106 to query for information about a user.

Component 109 encapsulates modules of the system 100 with which users interact. In particular, administration module 113 of component 109 allows an administrative user, with proper authorization, to view and update system parameters, in accordance with one embodiment. In addition, administration module 113 is used to register, configure and remove applications from the authentication/authorization server 103. Authentication module 116 maintains data pertinent to the user's registration with the system, such as the user's name and electronic mail address, and including the authentication modality (e.g., password, digital certificate) chosen by the user. Account manager module 117 allows users to manage their permits. For example, using account manager module 117, the user may confirm or revoke permissions to access applications for which the user has issued permits. In addition, account manager module 117 allows users to change their account preferences, such as the display of their name or their authentication modality. Account manager module 117 also allows a user to view permits created by that user and, if desired, send such permits. This module also allows the user to view permits sent to that user and send such permits to another if authorized to do so (i.e., further delegate permission to access the application).

Permit module 114 is responsible for displaying information about permits. Delegation module 115 is responsible for creating permits. In some embodiments, permit module 114 and delegation module 115 are implemented as a single component.

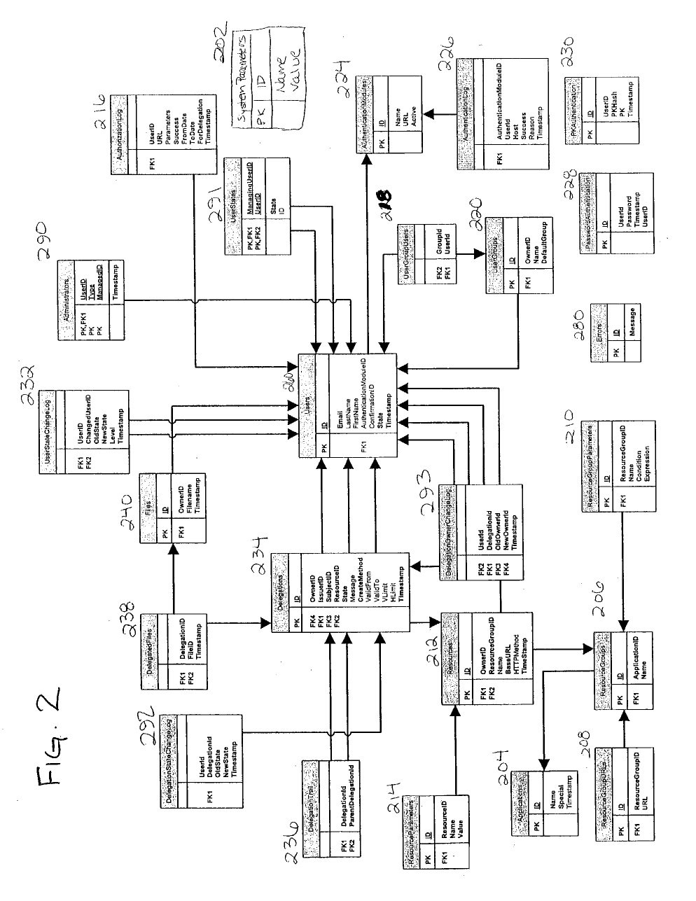

Database 110 stores the data generated in connection with the delegation, authorization and authentication activities performed by the various components of system 100. FIG. 2 illustrates an exemplary database schema for database 110 of FIG. 1. In embodiments in which system parameters can be configured by a user by way of the system 100, such parameters are maintained in table 202. Errors table 280 represents error messages that are displayed to the user. Application information, such as the resource identifier and name, are stored in table 204. Each resource group 206 is associated with an application 204. An application may own one or more resource groups. Associated with each resource group are one or more resource group RIs (e.g., URLs), which are stored in table 208. Also associated with each resource group are resource group parameters, which are stored in table 210. Information regarding resources, which belong to a particular resource group, is stored in table 212. Such information includes, in the preferred embodiment, an identification of the owner of the record (i.e., the user that created the resource), the resource group identifier, the name of the resource, and the base RI (e.g., base URL) for the particular resource. Each resource has associated with it resource parameters, which are stored in table 214.

Referring still to FIG. 2, information regarding users who are registered with the system is maintained in table 260. Such information includes, in the preferred embodiment, the user's electronic mail address, first and last name, an identifier of the authentication module used to authenticate the particular user, a confirmation identifier (used, in one embodiment, to identify a user upon registration with the system), the user's authentication state, and a time stamp. Table 216 maintains an authorization log indicating, by way of example, for a particular identified user, the RIs such user has accessed, the parameters associated with accessing the RI, whether the access attempt was successful, the time period for which the user is authorized to access the application, and whether the user is permitted to delegate the resource to others. To the extent user groups are employed (to allow users to build address books and create groups to which the user may delegate permits), tables 218 and 220 would be used to store such information. Table 291 stores information regarding the user's state (e.g., unregistered, pending, confirmed, disabled, revoked). Table 232 stores information regarding changes in the user's state. Thus, for example, for a particular user identifier or changed user identifier, table 232 stores the user's old state, new state, and level (i.e., the user's level relative to other users of the system, such as active, revoked, or blocked, as opposed to a system level state, such as unregistered, pending, active, revoked, or blocked, which is stored in table 260). Administrator table 290 maintains information regarding administrative users of the system 100, including the type of administrator described in the particular record (such as system, user, application or root) and managed identifier, which indicates the administrator who has rights to manage the administrator represented by the record.

Table 224 maintains configuration information for authentication module plug-ins, thereby enabling the system to accept from users a variety of different types of authentication modalities. Table 226 is a log of authentication attempts. Tables 230 and 228 store user-specific authentication information. In the event a user chooses to authenticate him/herself using a password, information regarding the same is maintained in table 228. Information regarding authentication using a digital certificate is maintained in table 230. To the extent additional authentication modalities can be used in connection with the system 100, additional data tables would be included to accommodate the same, within the scope of the present invention.

Information regarding delegations/permits is stored in tables 234, 236, 238, 240, 292 and 293. In the preferred embodiment, delegation table 234 stores information regarding the identity of the delegation owner (i.e., the individual who originally issued the permit), the identity of the issuer of the permit, the identity of the permit subject, the identity of the resource, the state of the permit (i.e., whether the permit has been revoked), the method for creating the permit (i.e., whether the delegation was created manually, where the user affirmatively delegates a resource to another user, or automatically, where the ownership of a delegation is changed), whether the resource is further delegable (including, in the preferred embodiment, any vertical and horizontal limitations on delegations), the time period in which the permit is valid, and whether a message is associated with the delegation. Table 236 stores information regarding the delegation trail, including the identity of a particular delegation and the identity of the parent delegation, from which the particular delegation was derived. To the extent any files are attached to a delegation, information regarding the same is stored in tables 240 and 238. For a particular delegation (identified by a delegation identifier), which has been delegated to a particular user (identified by a user identifier), delegation state change log 292 maintains information regarding the old and new states (i.e., active, blocked, or revoked)) of the delegation as of a certain time. For a particular user and delegation, delegation owner change log 293 maintains information regarding the identity of the old and new owner of the delegation.

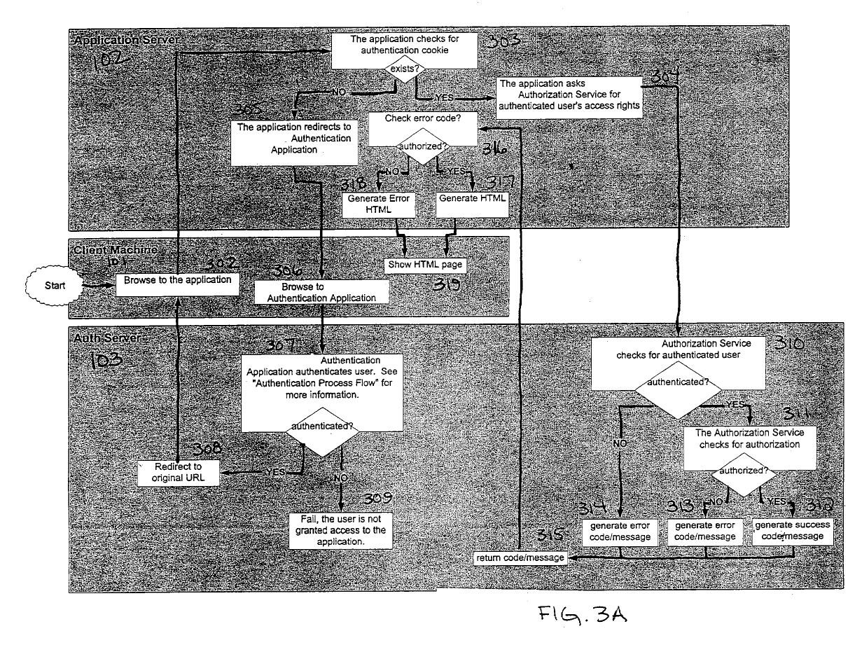

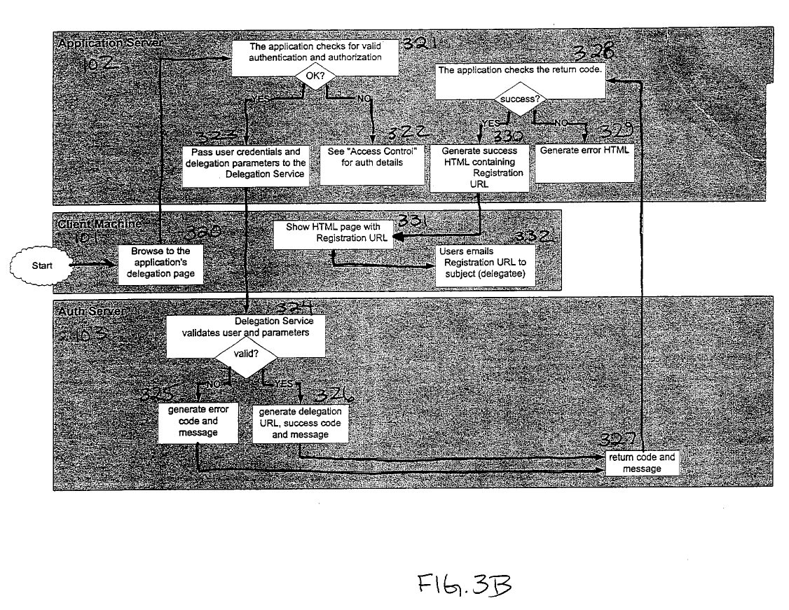

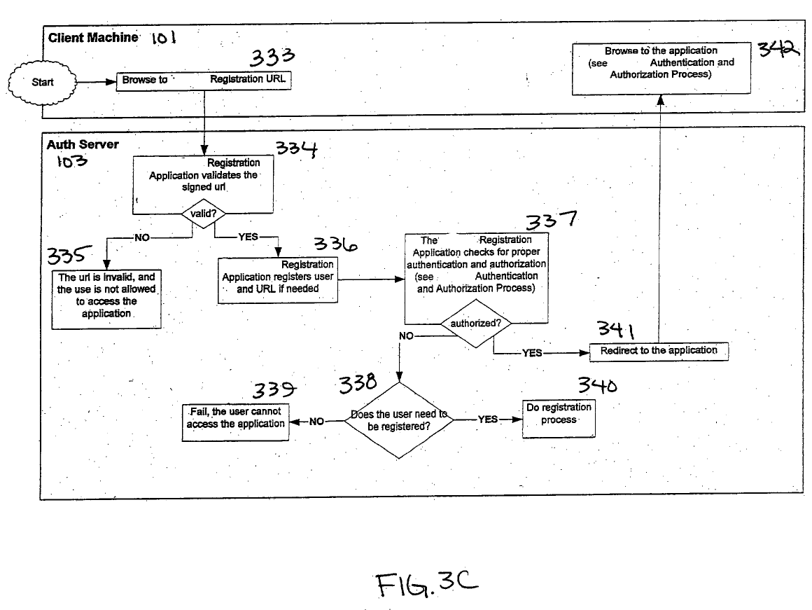

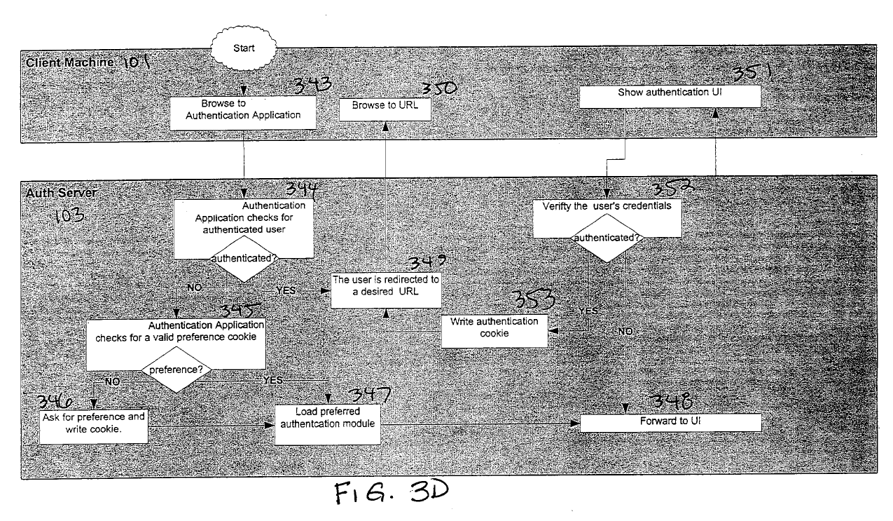

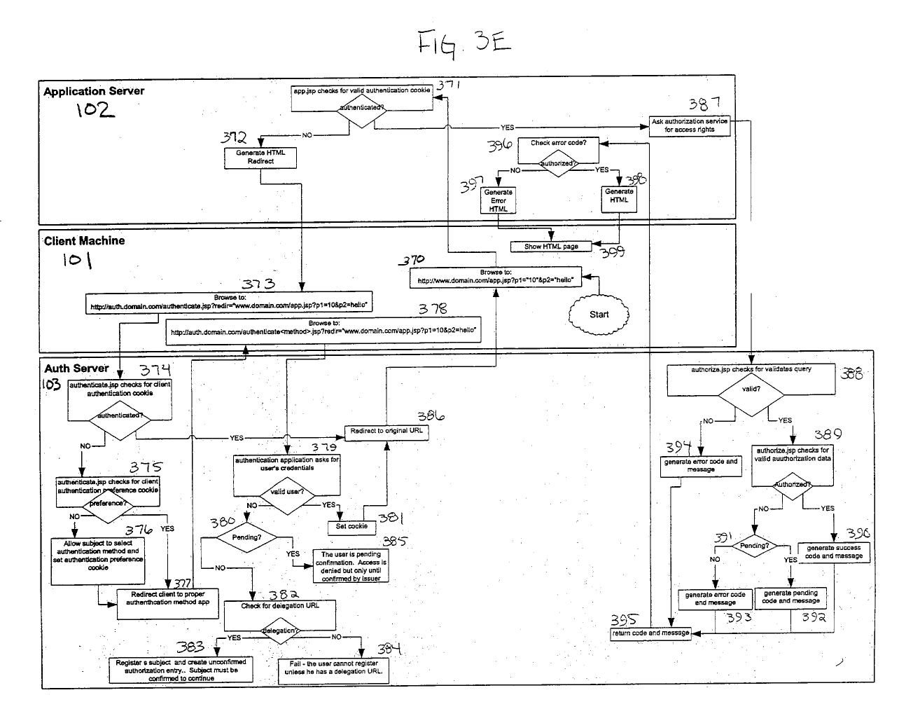

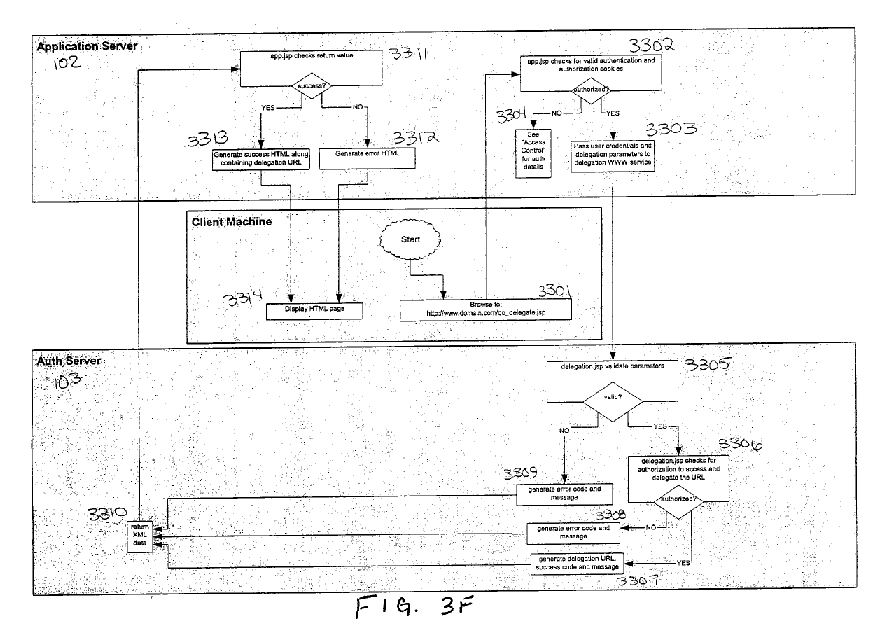

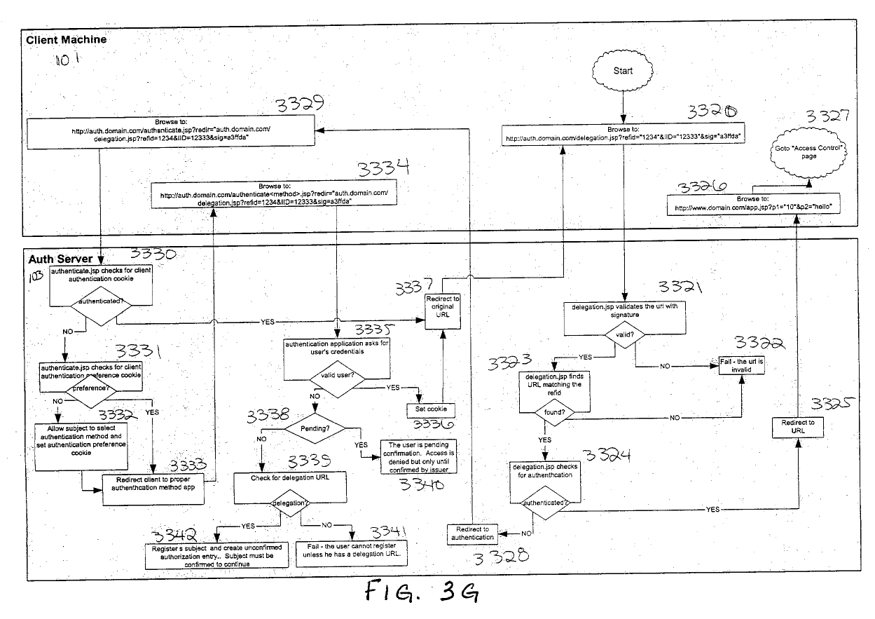

FIGS. 3A through 3D are flow diagrams illustrating the authorization, delegation, registration and authentication process flows, in accordance with one embodiment of the present invention. FIG. 3A illustrates one embodiment of the authorization process flow. In step 302, the user browses to an application of interest. In step 303, the application checks for the user's authentication cookie. If the cookie does not exist, the application redirects the user to the authentication application in step 305. In step 306, the user browses to the authentication application and an authentication attempt is made in step 307. FIG. 3D illustrates one embodiment of the authentication process flow. If the authentication attempt is not successful, the user is denied access to the application in step 309. If the authentication attempt is successful, the user is redirected to the original RI (step 302) corresponding to the application, in step 308. The application again checks for the authentication cookie in step 303. At this point, the authentication cookie exists and, in step 304, the application requests, from the authentication/authorization server 103, the authenticated user's access rights.

In step 310, the authorization component again checks whether the user is authenticated. If not, in step 314, an error code is generated and returned, in step 315, to the application server 102. The error code is checked in step 316 to determine if the user is authorized. If not, an HTML error page is generated in step 318 and displayed to the user in step 319. If the user is authorized, an HTML page is generated in step 317 and displayed to the user in step 319. If, in step 310, it is determined that the user is authenticated, in step 311, it is determined whether the user is authorized to access the application. If so, in step 312, a success code/message is generated, and the code/message is returned in step 315. If in step 311 it is determined that the user is not authorized, in step 313, and error code/message is generated and returned in step 315. The process then continues from step 316 as previously described.

FIG. 3B illustrates one embodiment of the delegation process flow. In step 320, the user browses to the application delegation web page. In step 321, the application checks to see that the user is authenticated and authorized to delegate a resource relating to the subject application. If not, in step 322, the steps set forth in FIG. 3A are performed (i.e., if the user is not authenticated, the authentication process will proceed; once the user is authenticated the authorization process commences). If so, the user's credentials and delegation parameters are passed to the authentication/authorization server 103 in step 323. In step 324, the user and the parameters inputted by the user are checked. If the user and parameters are valid, in step 326, a permit, success code and message are generated and returned to the user in step 327. If the user and/or the parameters are not valid, in step 325, an error code and message are generated and returned to the user in step 327. In step 328, the application server 102 checks the code and message returned in step 327. If the code indicates that validation was not successful, in step 329, an error page is generated and returned to the user. If the code indicates that the validation was successful, in step 330, an HTML page indicating this success is generated. The page contains a registration RI. In step 331, this page is shown to the user at client 101. In step 332, an electronic mail message containing the registration RI is sent to the subject (i.e., the delegatee).

In the preferred embodiment, system 100 includes a time out feature. In particular, the user's session will time out after a certain period of total time that the user has been logged onto the system and/or after a certain period of idle time. If one of the timeout values expire, the user will be required to log in and commence the authentication/authorization process anew. In other embodiments of the invention, a time out feature is not implemented.

While in the preferred embodiment, only users who are delegated a permit may register with the system, in other embodiments, any user may register with the system. FIG. 3C illustrates one embodiment of the registration process. In step 333, a user browses to the registration URL. In step 334, the authentication/authorization server 103 attempts to validate the URL. If the URL is invalid, in step 335, the user is not permitted to access the application. If the URL is valid, in step 336, the user is registered, along with the URL, if necessary. In step 337, the authentication/authorization server 103 checks for proper authentication and authorization (see FIGS. 3A and 3D). If the user is not authorized, it is determined in step 338 whether the user needs to be registered. If not, in step 339, the process fails and the user cannot access the registration application (i.e., because he is already registered). If the user needs to be registered, in step 340, user proceeds with the registration process. If in step 337 the user is authorized and authenticated, in step 341, the user is redirected to the application. In step 342, the user accesses the application.

FIG. 3D illustrates one embodiment of the authentication process flow. In step 343, the user browses to the authentication application. In step 344, the authentication/authorization server 103 checks to see if the user is authenticated. If not, in step 345, the authentication/authorization server 103 checks for a valid preference cookie. If there is no preference cookie, in step 346, the user is asked to provide his mode of authentication preference and a cookie, indicating this preference, is written to the client machine 101. Then, in step 347, the module corresponding to the user's preferred mode of authentication is loaded. Similarly, if a preference cookie exists in step 345, the module corresponding to the user's preferred mode of authentication is loaded in step 347. In step 348, the user is forwarded to the user interface used in connection with the authentication process. In step 351, this user interface is displayed on the client machine 101 and the user enters his credentials. In step 352, an attempt to verify the user's credentials is made. If the user is not authenticated with the credentials provided, the user is again forwarded to the user interface to provide the credentials a second time. If the user's credentials are verified, an authentication cookie is written in step 353. In the preferred embodiment, the cookie is a non-persistent cookie that is destroyed when the browser is closed. In addition, the authentication cookie contains no authentication data and only holds a date, an authenticated user identifier, and a signature. In step 349, the user is redirected to the desired RI and, in step 350, the user is able to browse to the RI using client 101. Referring back to step 344, if the user is authenticated, the user is redirected to the desired RI in step 340.

FIGS. 3E, 3F, and 3G are flow diagrams illustrating the access control, delegation, and retrieve delegation process flows in accordance with an alternate embodiment of the present invention. With reference to FIG. 3E, in step 370, the user browses to an application. In step 371, an application JSP checks for a valid authentication cookie. If a valid authentication cookie is identified, in step 387, authentication/authorization server 103 is asked for access rights. In step 388, an authorization JSP checks the validation query. If the query is not valid, in step 392, an error code and message are generated. If the query is valid, in step 389, an authorization JSP checks for valid authorization data. If valid authorization data is identified, in step 390, a success code and message are generated. If not, in step 391, it is determined if such authorization is pending. If so, a pending code and message are generated in step 392 and, if not, an error code and message are generated in step 393. In step 395, the appropriate code and message are returned. In step 396, the returned code is checked. If the user is authorized, an HTML page is generated in step 398 and shown to the user in step 399. If the user is not authorized, an HTML error page is generated in step 397 and shown to the user in step 399.

Returning again to step 371 of FIG. 3E, if the user is not authenticated, in step 372, a redirect is generated. In step 373, the user browses to an authentication page on authorization server 103. Here, in step 374, an authentication JSP determines if the user is authenticated. If so, in step 386, the user is redirected back to the application (step 370). If not, in step 375, an authentication JSP checks for the client authentication preference cookie. If there is no preference cookie, in step 376, the subject is permitted to select an authentication method and, upon doing so, an authentication preference cookie is set. Then, (or if a preference cookie exists in step 374), the client is redirected to the proper authentication method application according to the user's preference, in step 377.

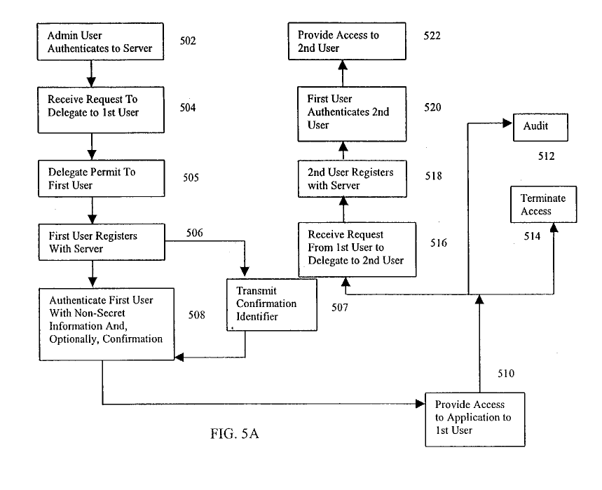

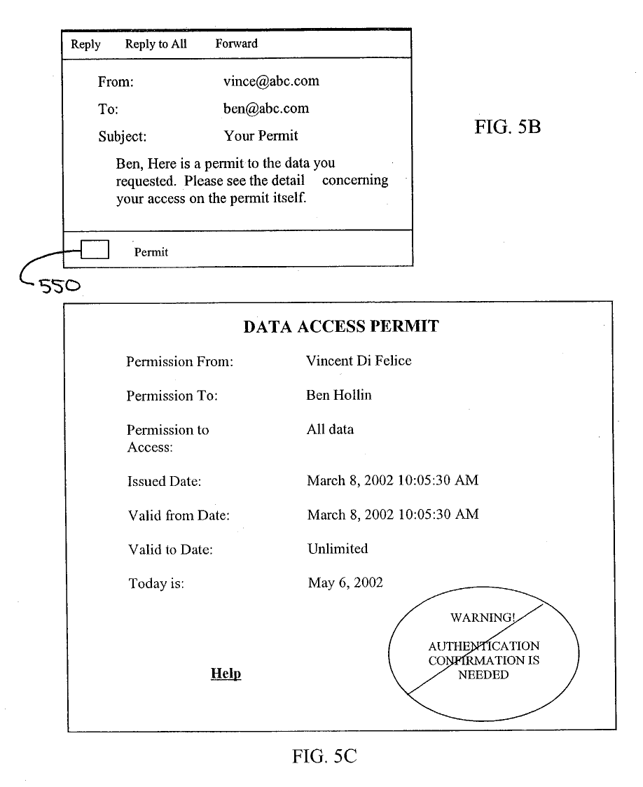

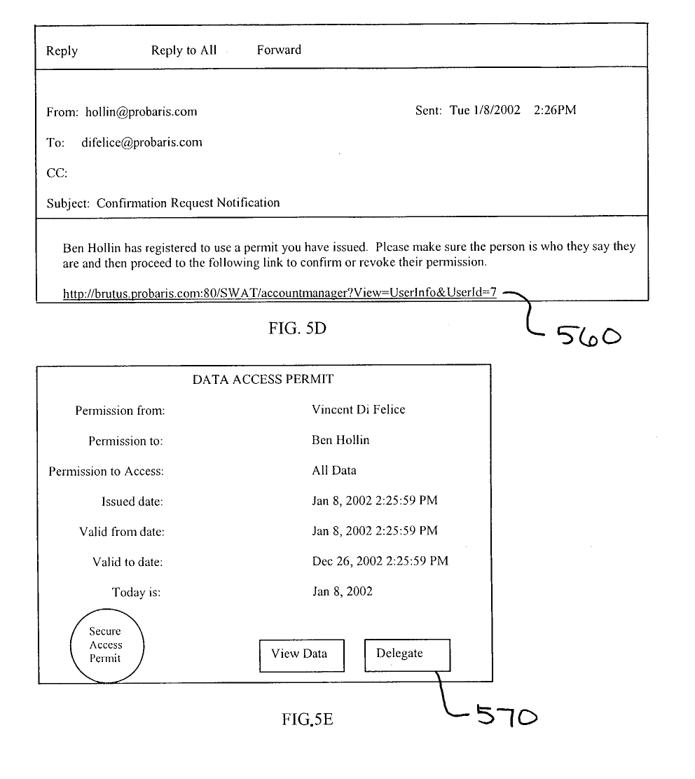

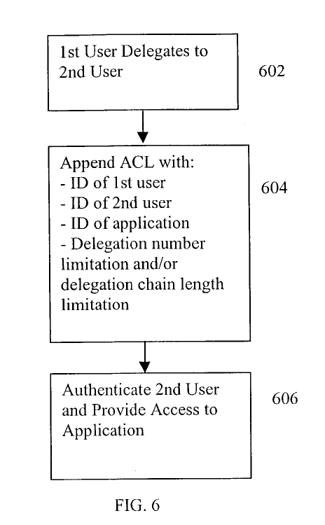

In step 378 of FIG. 3E, the user browses to the authentication page. In step 379, the authentication application asks for the user's credentials in step 379. If valid, a non-persistent authentication cookie is set in step 381, the user is redirected to the original URL in step 386, and browses back to the application in step 370. If not valid, it is determined in step 380 whether the user's authentication is pending. If pending, the user is denied access in step 385, but only pending confirmation from the permit issuer. If the user's authentication is not pending, in step 382, it is determined whether the user has a delegation URL. If not, in the preferred embodiment, in step 384, the user cannot register because he does not have a delegation URL. While in other embodiments it is possible for the user to register without having first been issued a delegation, this may not be preferred as it would result in cluttering the database 110 with unnecessary user registration information. If the user has a delegation URL, in step 383, the user is registered in an unconfirmed state. The user must be confirmed to continue. An example of this confirmation process is illustrated with respect to FIGS. 5A-5D.

Referring now to FIG. 3F, a delegation process flow chart, in accordance with another embodiment of the present invention, is illustrated. In step 3301, a user seeking to make a delegation browses to the delegation page. An application JSP checks for the existence of a valid authentication token in step 3302. In some embodiments, both an authentication cookie and an authorization cookie may be used. If the cookie does not exist, in step 3304, the user continues in accordance with the process flow illustrated in FIG. 3E. If the user is authenticated and authorized, in step 3303, the user's credentials and delegation parameters are passed to the delegation service on authentication/authorization server 103. In step 3305, a delegation JSP determines if the parameters are valid. If not, an error code and message is generated in step 3309. If the parameters are valid, in step 3306, the delegation JSP checks for authorization to access and delegate the URL. If authorized, in step 3307, a delegation RI is generated, along with a success code and message. If not authorized, in step 3308, an error code and message are generated. Depending on the outcome of step 3309 and 3306, XML data is returned in step 3310. In step 3311, the application JSP checks the data returned in step 3310. If the data indicates that the attempt to create a delegation was successful, in step 3313, a permit is generated (which contains the delegation RI) and displayed to the user in step 3314. If the data indicates the attempt was unsuccessful, in step 3312, an error page is generated and displayed to the user in step 3314.

In accordance with the retrieve delegation process flow chart of FIG. 3G, a user may retrieve a permit delegated to that user in accordance with one embodiment of the present invention. In step 3320, the user may browse to a location indicated in a permit issued to the user (e.g., by way of a URL). In one embodiment, in step 3321, a delegation JSP validates the delegation RI (e.g., the URL) with a signature. In step 3322, the process fails if the delegation RI is invalid. In step 3323, if the delegation RI is valid, the delegation JSP finds the application RI matching the reference identifier in the delegation RI. If not found, the process fails in step 3322. If found, in step 3324, the delegation JSP checks to see if the user has identified himself to the system. If so, in step 3325, the user is redirected to the application RI. In step 3326, the user browses to the application page. In step 3327, the user is taken through the access control process, illustrated by way of example in FIG. 3E. If in step 3324 the user is not authenticated, in step 3328, the user is redirected to a location for authentication.

In step 3329, the user browses to the authentication location. In step 3330, an authentication JSP checks for a client authentication cookie. If the user is authenticated, in step 3337, the user is redirected to the original RI. If no authentication cookie is found, in step 3331, the authentication JSP checks for the client authentication preference cookie. If no authentication cookie is found, in step 3332, the user is allowed to select an authentication method and the preference cookie is set. Then, or if an authentication cookie was found in step 3331, the client is redirected to the proper authentication method in step 3333. In step 3334, the user browses to the location for performing authentication and, in step 3335, the user's credentials are requested. If the user is valid, in step 3336, a cookie is set and the user is redirected to the original RI, in step 3337. If the user is not valid, it is determined in step 3338 if the user's authentication is pending. If so, in step 3340, access is denied, but only pending confirmation by the issuer of the permit (e.g., which might occur after authenticating the subject using non-secret information). In step 3338, if the user's authentication is not pending, it is determined if the user has been issued a delegation. If not, in step 3341, the process fails because, in the preferred embodiment, the user cannot register unless he has been delegated a permit. If the user has been delegated a permit, in step 3342, the user is granted an unconfirmed status pending confirmation. The permit issuer must confirm the user before the user is allowed to continue.

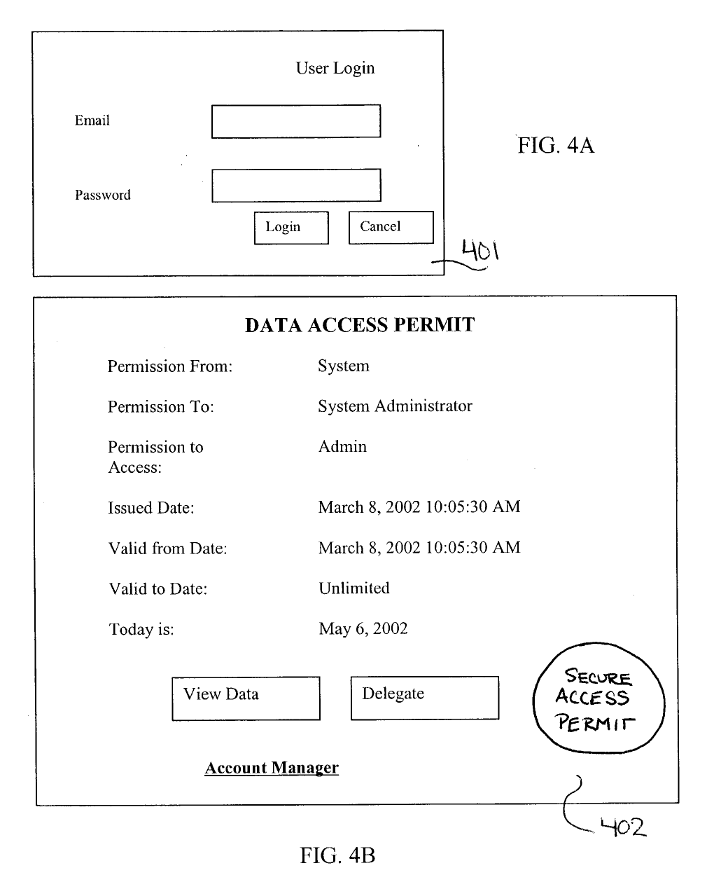

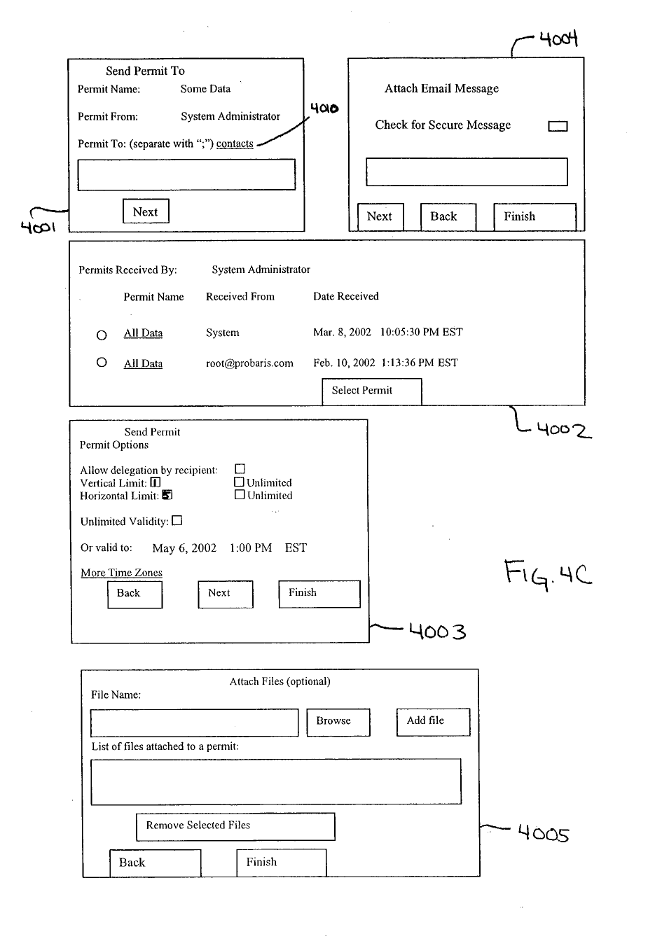

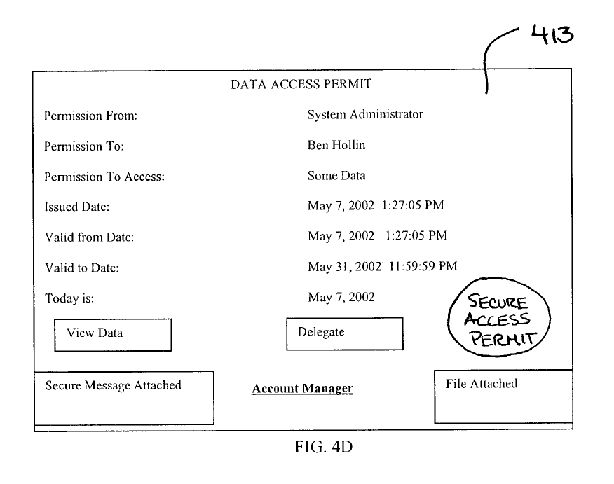

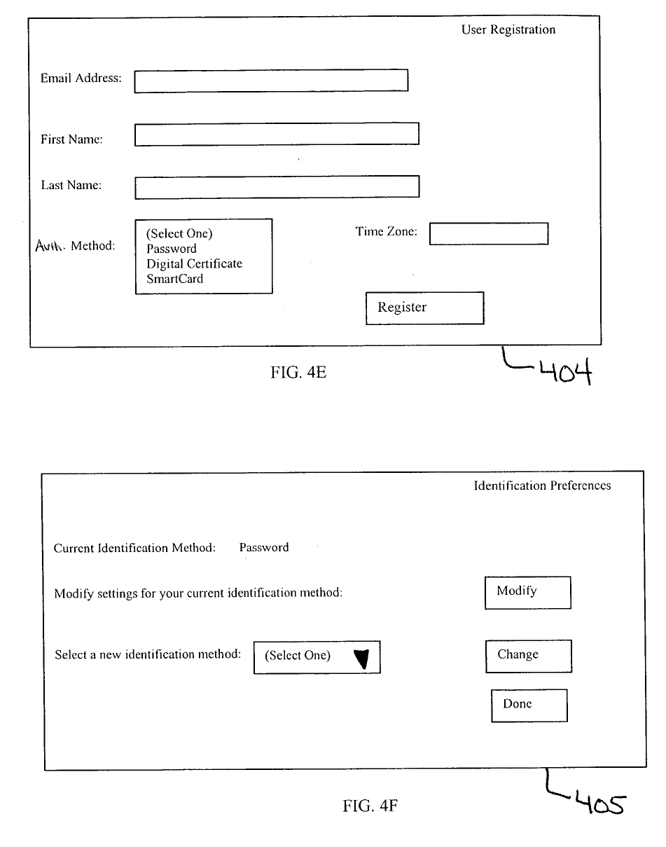

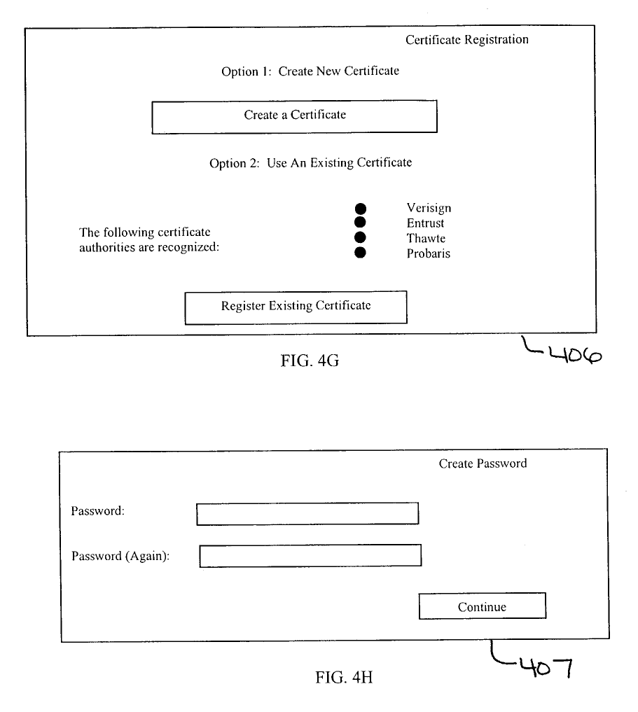

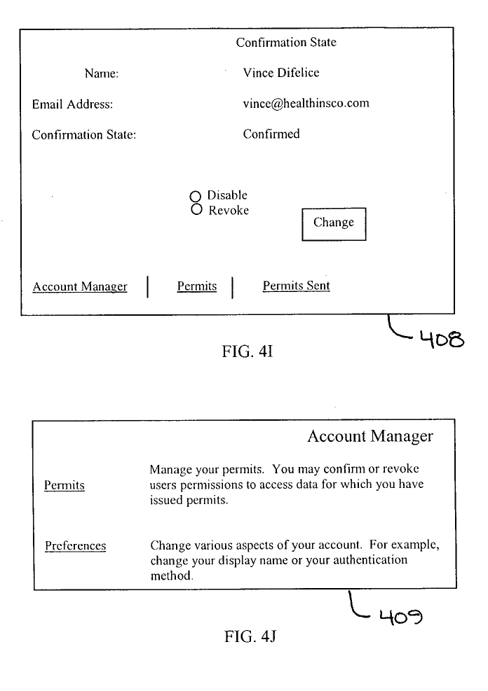

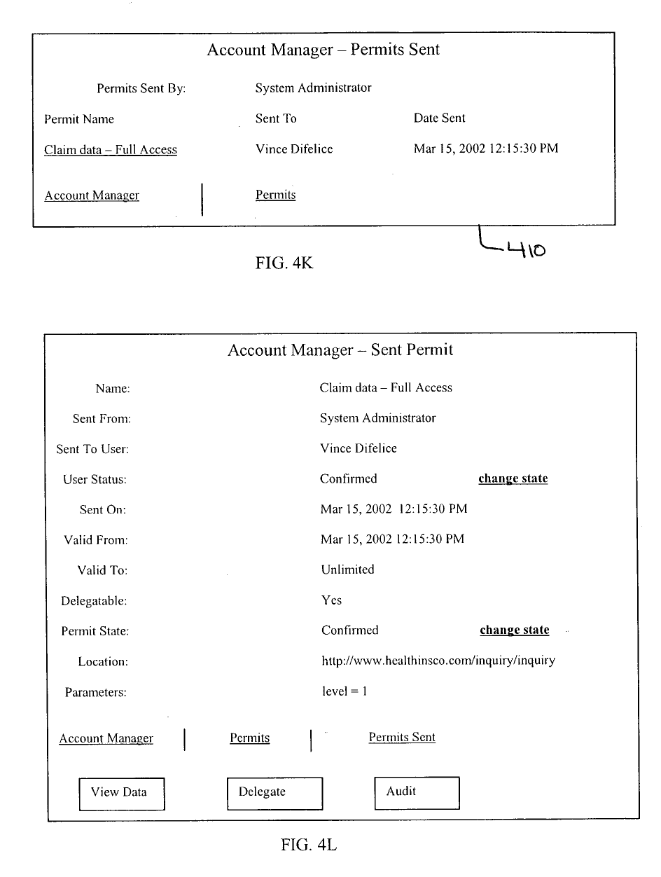

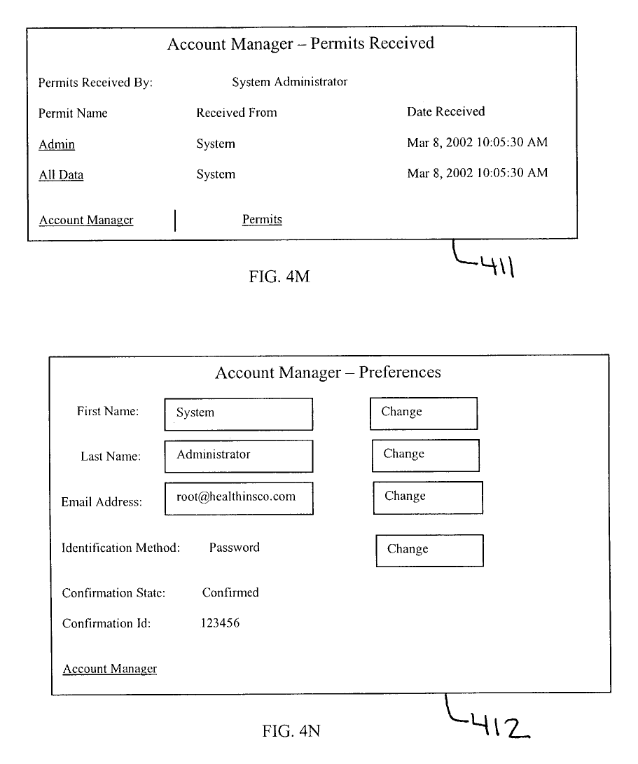

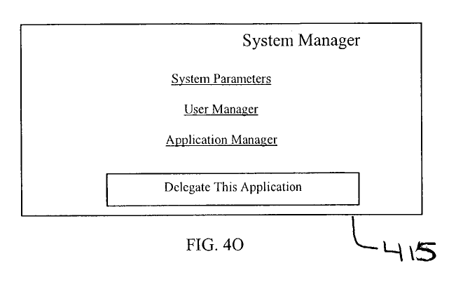

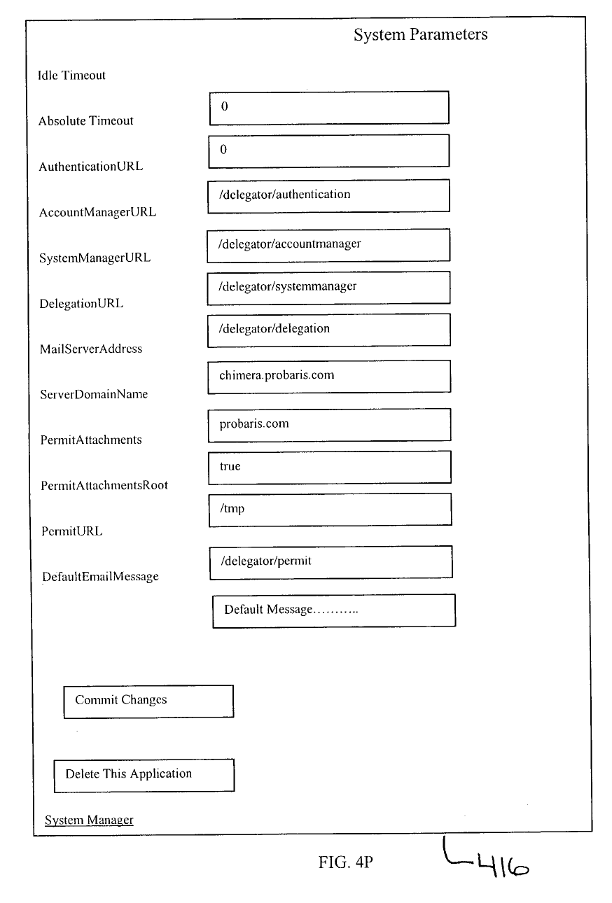

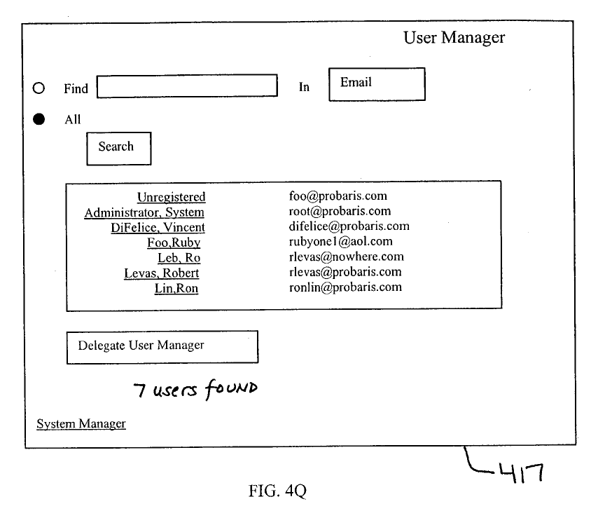

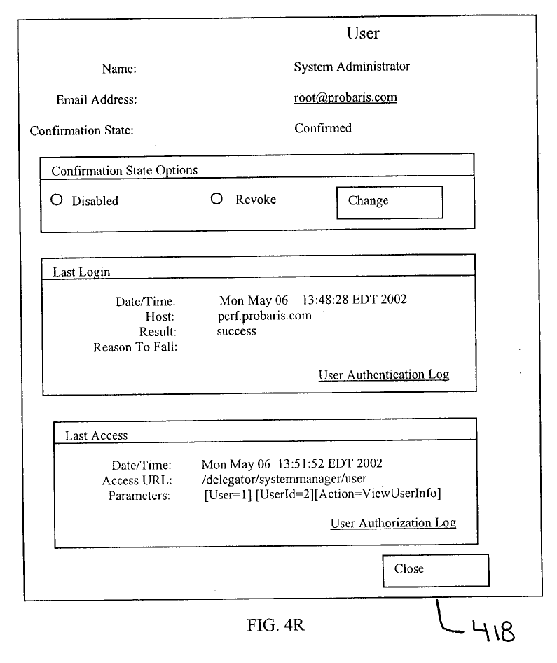

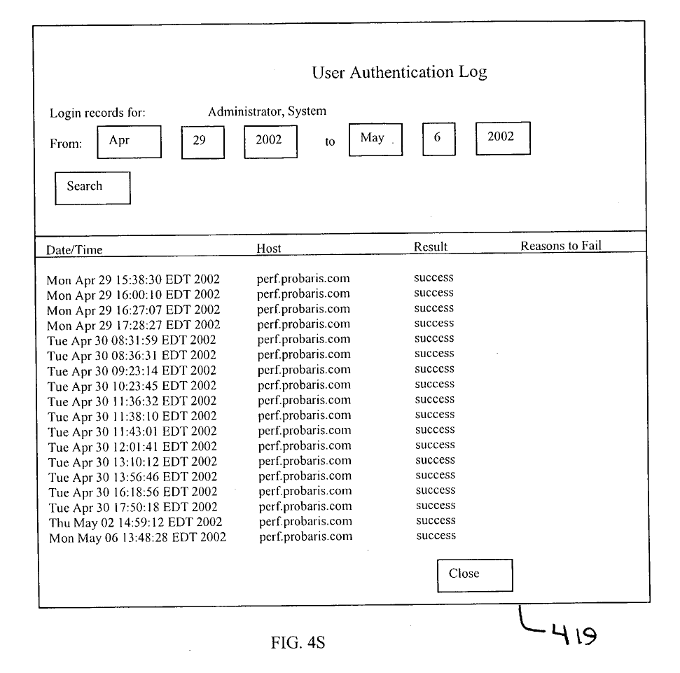

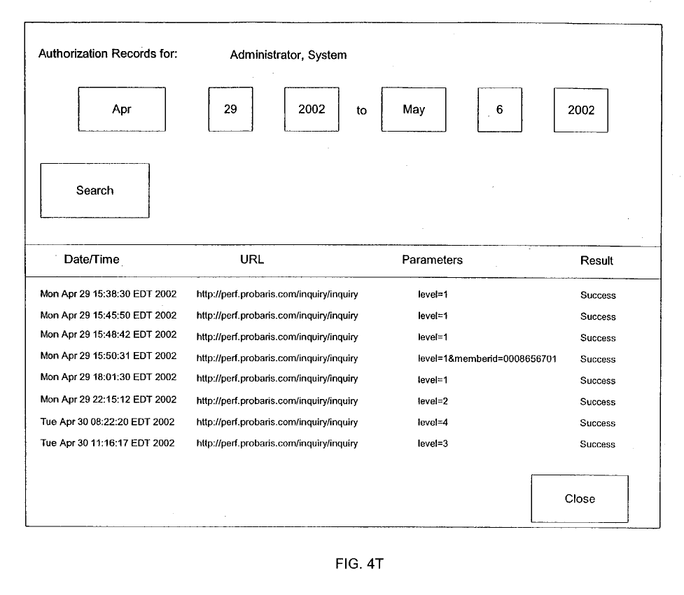

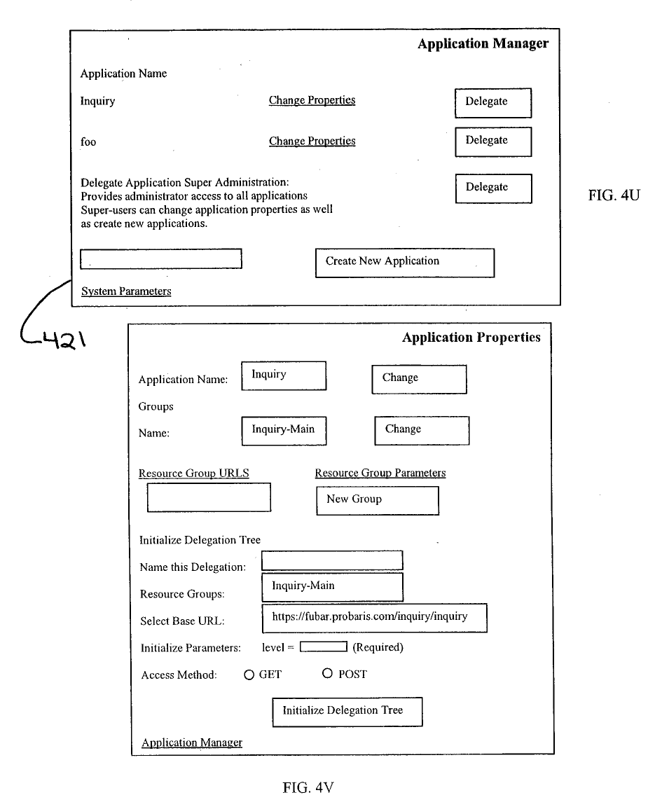

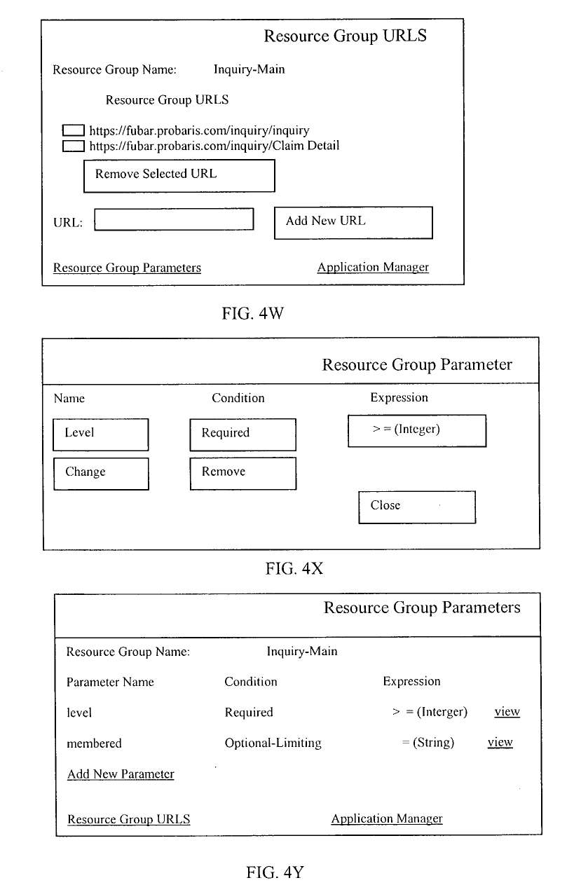

FIGS. 4A through 4Y illustrate exemplary user interfaces that may be used to access the functionality of the inventive system. In particular, an initial user of the system (e.g., a system administrator), who has authenticated to the system and is authorized to access a super-set of applications within the system, logs in using interface 401 shown in FIG. 4A. FIG. 4B shows an exemplary permit 402 delegated to the system administrator, indicating that the permission is from the system; to the system administrator; grants permission to access all administrative aspects of the system; the date of issuance; and dates of validity. Using permit 402, the system administrator can view data, delegate a permit to another, or access the account manager. Assuming the system administrator desires to delegate a permit, he will be directed (either from permit 402 or from a page from which delegations can be made or from some other entry point) to a series of interfaces 4001, 4002, 4003, 4004, and 4005, shown in FIG. 4C. Using interface 4001, the system administrator can identify the subject of the permit (i.e., the delegates) by way of, for example, an electronic mail address. The subject can be chosen from an address book or list of contacts 4010. Using interface 4002, the user may select the permit on which the delegation will be based, if the user has more than one permit that is relevant to the resource in question. Using interface 4003, the issuer may indicate whether further delegation of the permit is to be limited in any way. For example, the issuer may indicate that the permit may only be subsequently delegated by the subject five times (a horizontal limitation). Further, the issuer may indicate that the length of the delegation chain cannot exceed one (meaning that the subject of this particular permit may further delegate to others access to the data that is the subject of the permit, but may not delegate to such others the ability to further delegate). The vertical limitation must be set to 1 or more if the horizontal limit is to apply. The issuer may further indicate a validity period and, in connection therewith, the relevant time zone. Using interfaces 4004 and 4005, the issuer may provide a secure message to be sent along with the permit and attach any files to the permit. Upon sending the permit, the system administrator may be sent a return message, confirming that the permit was successfully transmitted.

The recipient of the permit from the system administrator may then further delegate the permission (if authorized to do so in his permit) to others. FIG. 4D illustrates an exemplary permit 413 received from the system administrator. Using permit 413, the user may view the data (i.e., application) that is the subject of the permit; delegate the permit to others; and view any secure messages or files attached to permit 413.

A user to whom a permission has been delegated, may further delegate the permission by way of the exemplary interfaces shown in FIGS. 4E-4H. Interface 404 of FIG. 4E allows a user to register, providing his name, electronic mail address and preferred method of authentication. The user may also change his identification preferences, using interface 405 of FIG. 4F. A variety of different authentication modalities are supported such as, by way of example and not limitation, digital certificates, passwords, smart cards, and biometrics. Other forms of authentication modalities will be known to those skilled in the art and are within the scope of the present invention. In the preferred embodiment, the system administrator determines what forms of authentication are acceptable and includes modules for accommodating the same in authentication/authorization server 103. If the user chooses to identify himself using a certificate, referring to FIG. 4G and interface 406, the user may, in some embodiments, create a new certificate for use in authenticating himself to the system or may register an existing certificate. Upon the certificate being successfully generated, a message will be displayed to the user, confirming the same. Alternatively, as shown in FIG. 4H, the user may create a password using interface 407.

With reference to FIG. 41, the system administrator may, using interface 408, check the status of other users of the system (e.g., unregistered, pending, confirmed, disabled, revoked) and may change the status of any such user (i.e., revoke any permissions delegated to the user or disable his registration status). Only system users with authorization to do so may change the confirmation state of other users in the system, except that any user who delegates a permit has the power to revoke that permit using the account manager. Allowing revocation of access immediately and at any time may be very valuable in certain circumstances.

Returning again to FIG. 4B, using the account manager feature, the system administrator may perform a variety of activities. A user may view and manage permits received and sent, using interface 409, as shown in FIG. 4J. For example, from interface 410 of FIG. 4K, a user may obtain access to permits sent by that user, including detail regarding the permit, as shown in FIG. 4L. Using interface 411 of FIG. 4M, a user may view information regarding permits received. Referring again to interface 409 of FIG. 4J, a user may elect to view and change his preferences. For example, with reference to FIG. 4N and interface 412, a user may view and change his first and last name, electronic mail address, and method of identification.

Referring to FIG. 4O, and interface 415, an authorized user may take advantage of the functionality of the system manager. Interface 416 of FIG. 4P allows a user to configure system parameters, such as the domain of the servers that are used to support the system; the RIs to which a user is directed for authentication, account manager, system manager, and delegation activities, as well as for accessing a permit delegated to the user; the address of the electronic mail server; whether attachments may be appended to delegations and where such attachments will be stored; and any default messages included with delegated permits. The authority to access and make changes to system parameters may also be further delegated using interface 416. In other embodiments, this functionality can be accessed external to system 100.

Interface 415 of FIG. 4O may also be used to access the user manager, as illustrated in interface 417 of FIG. 4Q. A user may find any other user who is registered with the system using interface 417 and obtain, using interface 418 of FIG. 4R, more detail about such other user's confirmation state, last login, and last access to the system. From interface 418, the user may obtain access to an authentication log (identifying records for the other user's login attempts shown in interface 419 of FIG. 4S) and to an authorization log (identifying records for the other user's application accesses shown in interface 420 of FIG. 4T). This auditing capability allows for the tracking, and reporting if necessary, of which users delegated access, the applications to which access was delegated, which users accessed applications, and when such access occurred. Auditing, and other administrative functions, are available to users with regard to permissions such users have delegated.

Interface 415 of FIG. 4O may also be used to access application manager, allowing a user to configure applications accessible via the system. Initially, it is necessary to provide one or more users (e.g., the system administrator) with full access to all features of the configured application. Upon registering an application, a unique identifier will be created by database 110 and assigned to the application (as illustrated in FIG. 2). Then, the application can be configured such that the RIs that make up the application are split into one or more resource groups. Each resource group has a set of parameters that can be used to determine authorization (i.e., that control access to the data displayed by the resource). For example, the resource parameters for the resource

http://www.some_domain.com/someApp?Id=1&View=All

are “ID” and “View”. All items in a particular resource group must be able to handle all of the resource group parameters as input. All resource parameters are not necessarily required for authorization. The resource parameters may be set at one of several levels of importance, such as required, optional-limiting (parameter is optional unless it exists in the delegation; then it must exist in the request), and optional-enabling (parameter is optional unless it does not exist in the delegation; then it must not exist in the request). Parameters may also be configured with a comparison operations (including but not limited to equals, greater than, less than, greater than or equal to, less than or equal to).

Referring to FIG. 4U, interface 421 allows a user to change properties of applications existing on the system and add new applications. A user may also delegate to others the ability to change application properties or add new applications using interface 421. For example, with reference to FIG. 4V, and an application named “Inquiry”, the user may identify the name of the group to which the application belongs and identify the resource group RIs and resource group parameters corresponding to the application. With reference to FIG. 4W, the user may view the RIs corresponding to the resource group for the identified application and add new RIs to the list. With reference to FIG. 4X, the user may insert resource group parameters for the application, including the name of the parameter, its condition, and any expression relating thereto. Two exemplary resource group parameters are shown with reference to FIG. 4Y.

For the application identified in FIG. 4V, the delegation tree may be initialized (i.e., pursuant to which the administrative user delegates access to the first user).

With reference to FIG. 5A, a flow chart illustrating a preferred embodiment of the method of the present invention is shown. In step 502, an administrative user, who is authorized to delegate a permission to a first user to access an application, authenticates to a server. In step 504, a request is received at the server from the administrative user to delegate to the first user a first permission to access at least a portion of the application. In step 505, the administrative user delegates to the first user a permit. FIG. 5B illustrates an exemplary electronic mail message in which the administrative user sends to the first user a permit pertaining to the subject data. Upon clicking on the permit icon 550, the first user may be shown the details of the permit, in the preferred embodiment, as illustrated in FIG. 5C.

However, as can be seen in FIG. 5C, the first user must register with the system and authenticate himself to the server prior to gaining access to the information. Thus, in step 506, the server receives a request from the first user to register with the server. Upon the first user seeking to register himself in connection with the permit received, in the preferred embodiment, the administrative user is sent an electronic mail message, indicating the same and informing the administrative user that he must authenticate the first user. An example of an electronic mail message of this sort is illustrated in FIG. 5D. In step 508, the administrative user authenticates the first user with non-secret information. This may occur by way of a telephone call, for example, where the administrative user knows the telephone number and voice of the first user. This confirmed registration technique is particularly advantageous because it allows for secure authentication without the need for passwords or other secret information to be passed between the issuer and subject of a permission. During this call, the administrative user confirms that the first user received a delegation from the administrative user. In some embodiments, in step 507, the server transmits to the first user a confirmation identifier upon the user registering with the system. The confirmation identifier is used as an additional item of authentication information, thereby providing added security to the system. Upon authenticating the first user, in the preferred embodiment, the administrative user follows the link 560 of FIG. 5D to confirm the permit. Upon confirming the permit, the first user is informed of the same and, in step 510, the first user is provided access to the application by way of the permit (shown, for example, in FIG. 5E). Steps 502, 504, 505, 506, 507 and 510 are performed over a computer network, such as the Internet.

In some embodiments, in step 512, the administrative user audits access of the first user to the application (as shown in FIGS. 4S and 4T). In still other embodiments, in step 514, the administrative user terminates access of the first user to the application (using, for example, interface 408 of FIG. 41).

In some embodiments, the first permission also includes permission to delegate a subsequent permission (based on the first permission) to a second user. For example, with reference to FIG. 5E, the first user may choose delegation button 570 on his permit to delegate further access. In these embodiments, in step 516, the server receives a request from the first user to delegate the subsequent permission to the second user. In step 518, the second user registers with the server. In step 520, the first user authenticates the second user with non-secret information. In step 522, the second user is provided access to the application. Steps 516, 518, and 522 are performed over a computer network, such as the Internet.

In certain embodiments, the delegation from one user to a second user can be specialized in terms of the limits placed on the delegation. For example, with reference to FIG. 6, in step 602, a first user delegates to a second user permission to access an application. In step 604, in connection with the delegation, an access control list is appended with the identity of the first user (the issuer); the identity of the second user (the subject); the identity of the application to which access is delegated; and a limitation on the number of further delegations the second user can make and, in some cases, a limitation on the length of the delegation chain (as shown in table 234 of FIG. 2). In step 606, upon authenticating the second user, the second user is provided with access to the application.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed:

1. In a system comprising at least one server, in which an administrative user is authenticated to the server and authorized to delegate permission to a first user to access an application, a method for providing secure access to the application, comprising:
(A) receiving at the server a request from the administrative user to delegate to the first user a first permission to access at least a portion of the application;
(B) receiving at the server a request from the first user to register with the server; and
(C) providing the first user access to the application,
wherein the administrative user authenticates the first user with authentication information, the authentication information comprising non-secret information; and
wherein steps (A), (B), and (C) are performed via a computer network.

2. The method of claim 1, wherein the first permission further comprises permission to delegate a subsequent permission to a second user, which subsequent permission is based on the first permission.

3. The method of claim 1, wherein the computer network comprises a publicly accessible global communications network.

4. The method of claim 1 further comprising:
(D) transmitting to the first user a confirmation identifier,
wherein the authentication information further comprises the confirmation identifier.

5. The method of claim 1, wherein the administrative user delegating to the first user comprises appending to an access control list a record comprising an administrative user identifier, a first user identifier, and a resource identifier.

6. The method of claim 5, wherein the record further comprises at least one of an access validity period; a delegation number limitation; and a delegation chain length limitation.

7. The method of claim 1, wherein the first user registers with the server by entering a user name, an electronic mail address, and a preferred identification mechanism.

8. The method of claim 7, wherein the preferred identification mechanism comprises at least one of a password, a digital certificate, and a smart card.

9. The method of claim 8, wherein the password is encrypted.

10. The method of claim 7, wherein the first user further enters a first user time zone.

11. The method of claim 7, wherein the system allows the first user to register using one of a plurality of types of the preferred identification mechanisms.

12. The method of claim 1, further comprising:
(D) allowing the administrative user to audit access of the first user to the at least a portion of the application.

13. The method of claim 1, further comprising:
(D) allowing the administrative user to terminate access of the first user to the at least a portion of the application.

14. The method of claim 2, further comprising:
(D) receiving at the server a request from the first user to delegate the subsequent permission to the second user;
(E) receiving at the server a request from the second user to register with the server; and
(F) providing the second user access to the at least a portion of the application,
wherein the first user authenticates the second user with second authentication information, the second authentication information comprising non-secret information; and
wherein steps (D), (E), and (F) are performed via a computer network.

15. A method of providing secure access to an application, comprising:
(A) receiving at a server a request from a first user to delegate to a second user permission to access an application;
(B) appending to an access control list a record comprising a first user identifier, a second user identifier, an resource identifier, and a delegation number limitation; and
(C) upon authenticating the second user, providing the second user with access to the application.

16. The method of claim 15 wherein the record further comprises a delegation chain length limitation.

17. A system for providing secure access to an application, comprising:
one or more servers that receive a request from an administrative user, over a computer network, to delegate to the first user a first permission to access at least a portion of the application, wherein the administrative user is authenticated to the server and authorized to delegate permission to a first user to access the application; that receive a request from the first user, over the computer network, to register with the server; and that provide the first user access to the application, over the computer network,
wherein the administrative user authenticates the first user with authentication information, the authentication information comprising non-secret information.

18. A system for providing secure access to an application over a computer network, in which an administrative user is authenticated and authorized to delegate permission to a first user to access an application, comprising:
means for receiving a request from the administrative user to delegate to the first user a first permission to access at least a portion of the application;
means for receiving a request from the first user to register with the server; and
means for providing the first user access to the application,
wherein the administrative user authenticates the first user with authentication information, the authentication information comprising non-secret information.

19. A machine readable medium for providing secure access to an application over a computer network, in which an administrative user is authenticated and authorized to delegate permission to a first user to access an application, comprising:
a first machine readable code that receives a request from the administrative user to delegate to the first user a first permission to access at least a portion of the application;
a second machine readable code that receives a request from the first user to register with the server; and
a third machine readable code that provides the first user access to the application,
wherein the administrative user authenticates the first user with authentication information, the authentication information comprising non-secret information.
